(19) United States
(12) Patent Application Publication
(10) Pub. No.: US 2025/0277346 A1
(43) Pub. Date: Sep. 4, 2025

(54) LOW-POISSON'S-RATIO ELASTOMER, SEAMLESS EXPANSION DEVICE AND CONSTRUCTION PROCESS

(71) Applicant: Jiangsu Changlu Zhizao Technology Co., Ltd., Nanjing (CN)

(72) Inventors: Zhixiang ZHANG, Nanjing (CN); Hui ZHANG, Nanjing (CN); Menglong ZHAO, Nanjing (CN); Youqiang PAN, Nanjing (CN); Zhidong CHEN, Nanjing (CN)

(73) Assignee: Jiangsu Changlu Zhizao Technology Co., Ltd., Nanjing (CN)

(21) Appl. No.: 19/211,195

(22) Filed: May 18, 2025

Related U.S. Application Data
(63) Continuation of application No. PCT/CN2023/133912, filed on Nov. 24, 2023.

(30) Foreign Application Priority Data
Dec. 30, 2022 (CN) 2022117344167

(51) Int. Cl. E01D 19/06; C08G 18/48; C08G 18/58; E04B 1/68

(52) U.S. Cl. CPC E01D 19/06; C08G 18/48; C08G 18/58; E04B 1/6801

(57) ABSTRACT

The present invention relates to the technical field of bridge expansion joint engineering, in particular to a low-Poisson's-ratio elastomer, a seamless expansion device and a construction process. The low-Poisson's-ratio elastomer includes, by weight, 70%-80% of a negative-Poisson's-ratio unit and 20%-30% of a high-toughness resin cementing material. The low-Poisson's-ratio elastomer provided by the invention achieves a low Poisson's ratio of a resin elastomer material of an expansion joint and solves the problem of changes of the surface flatness of a device caused by the unchanged size of a resin elastomer when the resin elastomer is stretched and compressed.

### CROSS-REFERENCE TO RELATED APPLICATIONS

The application claims priority to Chinese patent application No. 2022117344167, filed on Dec. 30, 2022, the entire contents of which are incorporated herein by reference.

### TECHNICAL FIELD

The present invention relates to the technical field of bridge expansion joint engineering, in particular to a low-Poisson's-ratio elastomer, a seamless expansion device and a construction process.

### BACKGROUND

Expansion joints, as important structures of bridges, not only concern the structural safety of the bridges, but also effectively alleviate squeezes or pulls between structures caused by deformations or vibrations of the bridges, and are an important guarantee of the road driving safety.

Existing resin seamless bridge expansion joint techniques are limited by the Poisson's ratio of materials, and resin elastomers will not undergo an obvious size change when deformed, so the resin elastomers are likely to bulge in the vertical direction when squeezed by bridges in the horizontal direction and will subside in the vertical direction when stretched by the bridges in the horizontal direction, and the surface evenness of the resin elastomers changes drastically with the temperature, leading to a stronger sense of bump and louder noise in the driving process, and compromising the driving comfort. Side surfaces of the resin elastomers are generally bonded to angle bars to be fixed, and the bonding interface cracks easily under the action of heavy-duty traffic and temperature variations, resulting in rusting of the angle bars and shortening the service life of the devices.

Information disclosed here merely aims to provide a better understanding of the overall background art of the present invention and should not be construed as acknowledging or indicating in any form that the information constitutes existing techniques commonly known by those skilled in the art.

### SUMMARY

The technical issue to be settled by the present invention is to provide a low-Poisson's-ratio elastomer, a seamless expansion device and a construction process to improve the shock resistance and bearing capacity of resin seamless expansion devices, lower driving noise caused by evenness changes, and improve driving comfort.

To fulfill the above objective, the present invention provides a low-Poisson's-ratio elastomer, including, by weight, 70%-80% of a negative-Poisson's-ratio unit and 20%-30% of a high-toughness resin cementing material.

Further, the low-Poisson's-ratio elastomer has a Poisson's ratio of 0-0.01 and a hardness of 60-70 IRHD, an elastic modulus at definite elongation of the low-Poisson's-ratio elastomer is less than or equal to 2 Mpa, and a bonding tensile strength of the low-Poisson's-ratio elastomer with a steel plate is greater than or equal to 2.5 Mpa.

It should be explained that the Poisson's ratio of the low-Poisson's-ratio elastomer provided by the invention is 0-0.01, such that when the low-Poisson's-ratio elastomer is squeezed by vehicle tires, a crushed portion (marked with a line) of low-Poisson's-ratio elastomer will produce a negative-Poisson's-ratio effect, such that shock vibrations may be effectively absorbed, and a vertical deformation is reduced, thus lowering driving noise and improving driving comfort.

Further, the negative-Poisson's-ratio unit is a concave hexagonal rubber elastomer and is made by injecting EPDM rubber granular materials molten at a high temperature into a concave quadrilateral mold and performing cutting by means of a V-cutter.

Because the concave hexagonal rubber elastomer is included in the low-Poisson's-ratio elastomer provided by the present invention, when the temperature falls in winter, the bridge concrete contracts, the ultralow-Poisson's-ratio resin elastomer will be stretched in the horizontal direction, and in the vertical direction, the elastic resin will contract while the negative-Poisson's-ratio unit will expand, such that the height of the ultralow-Poisson's-ratio resin elastomer in the vertical direction remains unchanged or is slightly decreased, thus reducing changes on the surface evenness of an expansion device at a low temperature in winter; and when the temperature rises in summer, the bridge concrete will expand, the ultralow-Poisson's-ratio resin elastomer will be compressed and deformed in the horizontal direction, and in the vertical direction, the elastic resin will expand while the negative-Poisson's-ratio unit will be compressed, such that the height of the ultralow-Poisson's-ratio resin elastomer in the vertical direction remains unchanged or is slightly increased, thus reducing changes of the surface evenness of the expansion device at a high temperature in the summer.

Further, the negative-Poisson's-ratio unit has a Poisson's ratio of −0.1-−0.05, a granularity of 16-30 meshes and a water content less than or equal to 1%.

Further, the high-toughness resin cementing material is prepared by mixing a component A and a component B in a proportion of 1:1, and by mass, the component A includes 50-65 parts of polyether polyol, 1-7 parts of calcium oxide, 30-50 parts of diethanolamine and 1-5 parts of a defoaming agent, and the component B includes 50-70 parts of isocyanate, 5-10 parts of bisphenol A type epoxy resin, 1-4 parts of 1,4-butanediol and 2-5 parts of an organometallic catalyst.

Further, a preparation method for the high-toughness resin cementing material includes the following steps:
S1: dehydrating the polyether polyol, stirring the dehydrated polyether polyol, the calcium oxide, the diethanolamine and the defoaming agent in a stirring container according to a design ratio for 30 min;
S2: stirring the isocyanate, the bisphenol A type epoxy resin, the 1,4-butanediol and the organometallic catalyst in a stirring container according to a design ratio for 30 min; and
S3: in use, mixing the component A obtained in S1, the component B obtained in S2 and the negative-Poisson's-ratio unit, and then pouring a resulting mixture in pits.

The present invention further provides a seamless expansion device, which is arranged above an expansion joint between two adjacent box girders. An asphalt concrete pavement layer is arranged above the box girders. The seamless expansion device includes two side templates, a comb plate, two external angle bars, a plurality of dowel bars and a low-Poisson's-ratio elastomer. Pits located on two sides of the expansion joint are dug in the box girders together with the asphalt concrete pavement layer. Upper portions of embedded bars located in the box girders are exposed to the pits. The two side templates are vertically and symmetrically arranged above the two sides of the expansion joint. The comb plate is horizontally laid above the side templates, and two ends of the comb plates are fixedly connected to the embedded bars by means of first dowel nails. The two external angle bars are respectively located on two sides of the comb plate. Adjusting base plates are arranged at bottoms of the external angle bars and fixed to the embedded bars by means of anchor bolts and second shear nails. A pouring trough is defined by the external angle bars, the adjusting base plates and the comb plate. A plurality of through-holes are formed in end surfaces, facing each other, of the external angle bars. The dowel bars are fixed in the through-holes. The low-Poisson's-ratio elastomer is poured in the pouring trough. Cement concrete is poured between the side templates and side walls of the pits.

Further, each dowel bar includes a threaded steel tube and a flexible sleeve, the flexible sleeve has a sealed end and an open end, a spring in a compressed state is arranged in the flexible sleeve, the open end of the flexible sleeve is disposed around the threaded steel tube and partially overlapped with the threaded steel tube, an overlap between the flexible sleeve and the threaded steel tube penetrates into the through-hole formed in the corresponding angle bar and clamped by means of retaining rings located on two sides of the angle bar, and the flexible sleeve is located in the pouring trough.

In the present invention, traditional metal bars may be used as the dowel bars, for example, a whole metal bar is inserted into the through-hole of each dowel bar. However, on one hand, because the connection strength between the metal dowel bars and the low-Poisson's-ratio elastomer is low, the metal bars are easily separated from the low-Poisson's-ratio elastomer; on the other hand, the size of the metal dowel bars hardly changes without the change of seasons, so the metal dowel bars will not deform synergistically with the low-Poisson's-ratio elastomer In view of this, the present invention specifically provides a novel dowel bar, wherein a portion, inserted into the cement concrete, of the dowel bar is a threaded steel tube, a portion, inserted into the low-Poisson's-ratio elastomer, of the dowel bar is a flexible sleeve, the flexible sleeve is formed in the low-Poisson's-ratio elastomer and is preferably made from polyurethane, thus being elastic. The dowel bar formed by the flexible sleeve and the spring may deform synergistically with the low-Poisson's-ratio elastomer to absorb interface stress, thus avoiding interface cracking.

Further, a limit rod is arranged at an end, in contact with the flexible sleeve, of the threaded steel tube, and the spring is partially disposed around the limit rod.

Further, each embedded bar is configured as an inverted U-shaped structure and includes a top horizontal section and vertical sections connected to two ends of the horizontal section.

Further, longitudinal bars are fixed between the embedded bars, and axes of the longitudinal bars is parallel to a length direction of the expansion joint.

The present invention further provides a construction process for the seamless expansion device, including the following steps:
S1: cutting and chiseling the asphalt concrete pavement layer and the box girders to expose the embedded bars and the bridge expansion joint, and in a case where no embedded bar is used, implanting steel bars equidistantly;
S2: laying the two side templates, fixing the side templates above the bridge expansion joint by welding, and spraying a foam adhesive to overlap joints between the side templates and the bridge expansion joint to seal the overlap joints;
S3: placing the comb plate above the side templates, and preliminarily fixing the first shear nails at a bottom of the comb plate to the embedded bars by binding;
S4: determining, by measurement, positions of the anchor bolts; after a design height, a distance to edges and an angle of the anchor bolts are determined, fixing the anchor bolts to the embedded bars by welding; enabling screws of the anchor bolts to penetrate into one sides of the adjusting base plates, and preliminarily binding and fixing the other sides of the adjusting base plates to the embedded bars by means of the second shear nails at the bottoms of the adjusting base plates; adjusting positions of the adjusting base plates to design positions, and welding the second shear nails to the embedded bars;
S5: welding the two ends of the comb plate to the adjusting base plates, welding the side templates to a bottom surface of the comb plate, spraying a foam adhesive to welding joints, unbinding the first shear nails at a bottom of the comb plate from the embedded bars, and fixing the first shear nails to the embedded bars by welding;
S6: placing the external angle bars on the adjusting base plates, fixing the external angle bars by means of nuts of the anchor bolts, enabling the dowel bars to penetrate into preformed holes in the external angle bars, and fixing the dowel bars to the external angle bars by means of the retaining rings, such that the pouring trough is defined;
S7: pouring the cement concrete via gaps between the external angle bars and the asphalt concrete pavement layer, and starting a next construction step when the concrete is cured to 90% of design strength;
S8: uniformly mixing the negative-Poisson's-ratio unit and the high-toughness resin cementing material in proportion to form a low-Poisson's ratio resin mixture, directly pouring the low-Poisson's ratio resin mixture in the pouring trough until the low-Poisson's ratio resin mixture is as high as the asphalt concrete pavement layer on two sides, performing secondary trowelling on uneven portions, and forming the low-Poisson's-ratio elastomer after solidification; and $9: resuming traffic after curing for 24 hrs.

The present invention has the following beneficial effects:
(1) An ultralow Poisson's ratio of a resin elastomer is realized by means of the negative-Poisson's-ratio unit, the deformation capacity is improved by 25%, and the resin elastomer may be applied to bridge expansion joints with a maximum deformation of 200 mm;
(2) The driving comfort is good, the Poisson's ratio of the resin elastomer may be close to a Poisson's ratio lower limit according to different proportions, and the influence of the temperature in different seasons on the surface evenness of the resin elastomer is effectively reduced; the elastomer may partially reach a negative Poisson's ratio, such that impact force from vehicles may be effectively absorbed, deformation of the elastomer caused when the elastomer is squeezed by vehicles is reduced, and compared with traditional seamless resin expansion joints, noise is lowered by 10-15 dB;
(3) The bearing capacity of the resin elastomer is effectively improved, and under the same vertical deformation condition, the dynamic stability is greater than 44000/mm, the bearing capacity is improved by about 50%, and the resin elastomer is adaptable to heavy-duty traffic environments;
(4) The interface bonding capacity is good, the dowel bars are used to enhance interface connection and transfer an impact load from vehicles into the cement concrete in an anchorage region, and the problem of cracking of interfaces of the angle bars and the cement concrete is solved;
(5) The construction efficiency is high, single-layer angle bars are used, no other stabilizing element is arranged, a full-thickness direct pouring process of the resin elastomer is realized, and layer-by-layer pavement is not needed, such that the construction efficiency is improved by over 20%;
(6) Maintenance is easy, the ultralow-Poisson's ratio resin elastomer may be directly cut and removed, traffic may be resumed after similar materials are filled and cured, partial filling and lane-level maintenance may be realized, and maintenance may be easily performed at a low cost.

### BRIEF DESCRIPTION OF DRAWINGS

To better clarify the technical solutions in the embodiments of the present invention or the prior art, drawings used for describing the embodiments of the present invention or the prior art are briefly introduced below. Obviously, the drawings in the following description merely illustrate some embodiments recorded in the present invention, and those ordinarily skilled in the art may obtain other drawings according to the following ones without creative labor.

FIG. 1 is a schematic structural diagram of a negative-Poisson's-ratio unit according to one embodiment of the present invention;

FIG. 2 is a schematic structural diagram of a seamless expansion device according to one embodiment of the present invention;

FIG. 3 is a schematic structural diagram of a dowel bar according to one embodiment of the present invention.

### REFERENCE SIGNS

1, box girder; 2, asphalt concrete pavement layer; 3, side template; 4, comb plate; 5, external angle bar; 6, dowel bar; 7, low-Poisson's-ratio elastomer; 8, embedded bar; 9, first shear nail; 10, adjusting base plate; 11, anchor bolt; 12, second shear nail; 13, cement concrete; 14, threaded steel tube; 15, flexible sleeve; 16, spring; 17, retaining ring; 18, limit rod; 19, longitudinal bar.

### DETAILED DESCRIPTION OF THE EMBODIMENTS

The technical solutions in the embodiments of the present invention are clearly and completely described below in conjunction with accompanying drawings of the embodiments of the present invention. Obviously, the embodiments described below are merely illustrative ones, and are not all possible ones of the present invention.

It should be noted that when one element is referred to as being “fixed” to the other element, it may be directly fixed to the other element, or there may be an intermediate element between the two elements. When one element is construed as being “connected” to the other element, it may be directly connected to the other element, or there may be an intermediate element between the two elements. The terms “vertical”, “horizontal”, “left” and “right” and similar expressions used here are merely for the purpose of description and do not indicate a unique implementation.

Unless otherwise defined, all technical and scientific terms used here have the same meaning as commonly understood by those skilled in the art. Terms used in the description of the present invention are merely for the purpose of describing specific embodiments and are not intended to limit the present invention. The term “and/or” used here indicate the inclusion of any one and all combinations of one or more related items listed.

### Embodiment 1

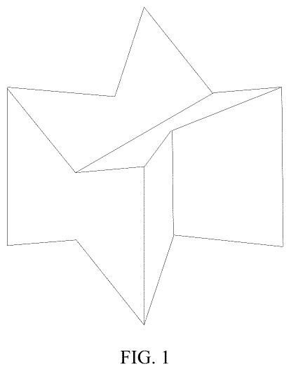

As shown in FIGS. 1-3, this embodiment provides a seamless expansion device using a low-Poisson's-ratio resin elastomer, including: two side templates 3, a comb plate 4, two external angle bars 5, a plurality of dowel bars 6, a low-Poisson's-ratio elastomer 7 and longitudinal bars 19. The whole seamless expansion device is mounted above an expansion joint between two adjacent box girders 1, and pits are dug in the box girders 1 together with an asphalt concrete pavement layer 2 along two sides of the expansion joint and used for mounting the seamless expansion device. Specifically, upper portions of embedded bars 8 located in the box girders 1 are exposed to the pits, the two side templates 3 are vertically and symmetrically arranged above the two sides of the expansion joint, the comb plate 4 is horizontally laid above the side templates 3, two ends of the comb plate 4 are fixedly connected to the embedded bars 8 by means of first shear nails 9, the two external angle bars 5 are respectively located on two sides of the comb plate 4, adjusting base plates 10 are arranged at the bottoms of the external angle bars 5, the adjusting base plates 10 are fixed to the embedded bars 8 by means of anchor bolts 11 and second shear nails 12, a pouring trough is defined by the external angle bars 5, the adjusting base plates and the comb plate 4, a plurality of through-holes are formed in the end surfaces, facing each other, of the external angle bars 5, the dowel bars 6 are fixed in the through-holes, the low-Poisson's-ratio elastomer 7 is poured in the pouring trough, and cement concrete 13 is poured between the side templates 3 and the side walls of the pits.

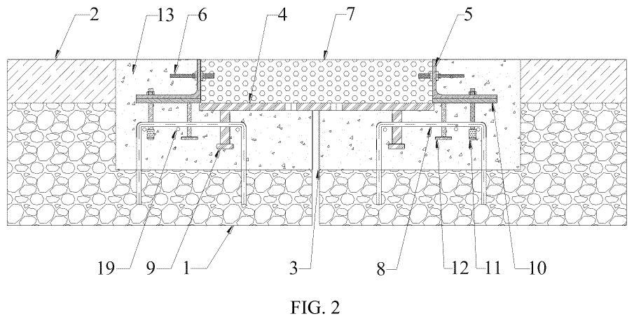

It may be known from FIG. 2 that each embedded bar 8 is configured as an inverted U-shaped structure and includes a top horizontal section and vertical sections connected to two ends of the horizontal section. Each embedded bar 8 is formed by continuously bending a steel bar and is a common structural member in the construction site. To reinforce and secure the embedded bars 8, the longitudinal bars 19 are fixed between the embedded bars 8, and axes of the longitudinal bars 19 are parallel to a length direction of the expansion joint.

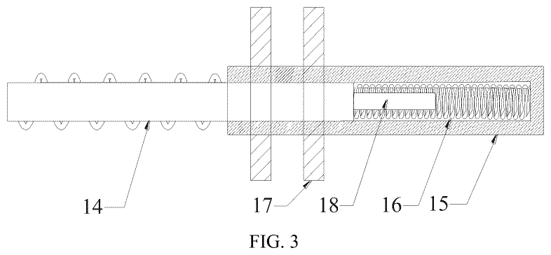

Specifically, as shown in FIG. 3, each dowel bar 6 adopted in this embodiment includes a threaded steel tube 14 and a flexible sleeve 15, one end of the flexible sleeve 15 is sealed, the other end of the flexible sleeve 15 is open, a spring 16 in a compressed state is arranged in the flexible sleeve 15, the open end of the flexible sleeve 15 is disposed around the threaded steel tube 14 and partially overlapped with the threaded steel tube 14, an overlap between the flexible sleeve 15 and the threaded steel tube 14 penetrates into the through-hole of the corresponding angle bar and clamped by means of retaining rings 17 located on two sides of the angle bar, and the flexible sleeve 15 is located in the pouring trough.

Specifically, a preparation method for the low-Poisson's-ratio elastomer 7 adopted in this embodiment includes the following steps:
S1: by weight, 60 parts of polyether polyol were dehydrated, and the dehydrated polyether polyol, 4 parts of calcium oxide, 40 parts of diethanolamine and 2 parts of a defoaming agent were stirred in a stirring container according to a design ratio for 30 min;
S2: 60 parts of isocyanate, 8 parts of bisphenol A type epoxy resin, 3 parts of 1,4-butanediol and 4 parts of organometallic catalyst were stirred in a stirring container according to a design ratio for 30 min; and
S3: in use, a component A obtained in S1 and a component B obtained in S2 were mixed to obtain a mixture, and the mixture and a negative-Poisson's-ratio unit were mixed according to a weight ratio of 25:75 and then poured in the pits.

It should be noted that a construction process for the seamless expansion device provided by this embodiment includes the following steps:
S1: the asphalt concrete pavement layer 2 and the girder boxes 1 were cut and chiseled to expose the embedded bars 8 and the bridge expansion joint, and in a case where no embedded bar 8 was used, steel bars were implanted equidistantly;
S2: the two side templates 3 were laid and then fixed above the bridge expansion joint by welding, and a foam adhesive was sprayed onto overlap joints between the side templates 3 and the expansion joint to seal the overlap joints;
S3: the comb plate 4 was placed above the side templates 3, and the first shear nails 9 at the bottom of the comb plate 4 were preliminarily fixed to the embedded bars 8 by binding;
S4: positions of the anchor bolts 11 were determined by measurement; after a design height, a distance to edges and an angle of the anchor bolts 11 were determined, the anchor bolts 11 were fixed to the embedded bars 8 by welding; screws of the anchor bolts 11 penetrated into one sides of the adjusting base plates 10, and the other sides of the adjusting base plates 10 were preliminarily bound and fixed to the embedded bars 8 by means of the second shear nails 12 at the bottoms of the adjusting base plates 10; the positions of the adjusting base plates 10 were adjusted to the design positions, and then the second shear nails 12 were welded to the embedded bars 8;
S5: the two ends of the comb plate 4 were welded to the adjusting base plates 10, then the side templates 3 were welded to a bottom surface of the comb plate 4, a foam adhesive was sprayed to the weld joints, and the first shear nails 9 at the bottom of the comb plate 4 were unbound from the embedded bars 8 and fixed to the embedded bars 8 by welding;
S6: the external angle bars 5 were placed on the adjusting base plates 10 and fixed by means of nuts of the anchor bolts 11, and the dowel bars 6 penetrated into preformed holes in the external angle bars 5 and were fixed to the external angle bars 5 by means of the retaining rings 17, such that the pouring trough was defined;
S7: the cement concrete 13 was poured via gaps between the external angle bars 5 and the asphalt concrete pavement layer 2, and a next construction step was started when the concrete was cured to 90% of the design strength;
S8: the negative-Poisson's-ratio unit and the high-toughness resin cementing material were uniformly mixed in proportion to form a low-Poisson's-ratio resin mixture, the low-Poisson's-ratio resin mixture was directly poured into the pouring trough until the low-Poisson's ratio resin mixture was as high as the asphalt concrete pavement layer on two sides, secondary trowelling was performed on uneven portions, and the low-Poisson's-ratio elastomer 7 was formed after solidification; and
S9: traffic was resumed after curing for 24 hrs.
   Performance Test Results after Construction are Shown Below:

| Project | | Unit | Embodiment |
|---|---|---|---|
| Construction time | | d | 4.5 |
| Height difference | (50° C.) | mm | +2 |
| variation of joint | (23° C.) | | 0 |
| | (−5° C.) | | −1 |

| | | |
|---|---|---|
| Noise peak | dB | 65 |
| Deformation (23° C.) | mm | 140 |
| Dynamic stability (70° C.) | per mm | 44700 |
| Pull strength of interfacial combined | MPa | 3.70 |
| structure (23° C.) | | |

It may be known, from the above test results, that by adopting the seamless expansion device provided by this embodiment, after traffic is resumed, noise is low, the dynamic stability is greater than 44000/mm and the bearing capacity is improved by about 50% under the same vertical deformation condition, and the seamless expansion device is adaptable to heavy-duty traffic environments; and the overall interface bonding strength is higher, and the service life is longer.

Those skilled in the art should understand that the present invention is not limited to the above embodiments, and the above embodiments and descriptions are merely used to explain the principle of the present invention. Various modifications and improvements may be made to the present invention without departing from the spirit and scope of the present invention, and all these modifications and improvements should also fall within the protection scope of the present invention. The protection scope of the present invention should be defined by the appended claims and their equivalents.

What is claimed is:

1. A low-Poisson's-ratio elastomer, comprising, by weight, 70%-80% of a negative-Poisson's-ratio unit and 20%-30% of a high-toughness resin cementing material.

2. The low-Poisson's-ratio elastomer according to claim 1, wherein the low-Poisson's-ratio elastomer has a Poisson's ratio of 0-0.01 and a hardness of 60-70 IRHD, an elastic modulus at definite elongation of the low-Poisson's-ratio elastomer is less than or equal to 2 Mpa, and a bonding tensile strength of the low-Poisson's-ratio elastomer with a steel plate is greater than or equal to 2.5 Mpa.

3. The low-Poisson's-ratio elastomer according to claim 1, wherein the negative-Poisson's-ratio unit is a concave hexagonal rubber elastomer and is made by injecting EPDM rubber granular materials melted at a high temperature into a concave quadrilateral mold and performing cutting by means of a V-cutter.

4. The low-Poisson's-ratio elastomer according to claim 1, wherein the high-toughness resin cementing material is prepared by mixing a component A and a component B, and by mass, the component A comprises 50-65 parts of polyether polyol, 1-7 parts of calcium oxide, 30-50 parts of diethanolamine and 1-5 parts of a defoaming agent, and the component B comprises 50-70 parts of isocyanate, 5-10 parts of bisphenol A type epoxy resin, 1-4 parts of 1,4-butanediol and 2-5 parts of an organometallic catalyst.

5. The low-Poisson's-ratio elastomer according to claim 4, wherein a preparation method for the high-toughness resin cementing material comprises the following steps:
S1: dehydrating the polyether polyol, stirring the dehydrated polyether polyol, the calcium oxide, the diethanolamine and the defoaming agent in a stirring container according to a design ratio for 30 min;
S2: stirring the isocyanate, the bisphenol A type epoxy resin, the 1,4-butanediol and the organometallic catalyst in a stirring container according to a design ratio for 30 min; and
S3: in use, mixing the component A obtained in S1, the component B obtained in S2 and the negative-Poisson's-ratio unit, and then pouring a resulting mixture in pits.

6. A seamless expansion device, arranged above an expansion joint between two adjacent box girders, an asphalt concrete pavement layer being arranged above the box girders, wherein the seamless expansion device comprises two side templates, a comb plate, two external angle bars, a plurality of dowel bars and a low-Poisson's-ratio elastomer, pits located on two sides of the expansion joint are dug in the box girders together with the asphalt concrete pavement layer, upper portions of embedded bars located in the box girders are exposed to the pits, the two side templates are vertically and symmetrically arranged above the two sides of the expansion joint, the comb plate is horizontally laid above the side templates, two ends of the comb plates are fixedly connected to the embedded bars by means of first dowel nails, the two external angle bars are respectively located on two sides of the comb plate, adjusting base plates are arranged at the bottoms of the external angle bars and fixed to the embedded bars by means of anchor bolts and second shear nails, a pouring trough is defined by the external angle bars, the adjusting base plates and the comb plate, a plurality of through-holes are formed in end surfaces, facing each other, of the external angle bars, the dowel bars are fixed in the through-holes, the low-Poisson's-ratio elastomer is poured in the pouring trough, and cement concrete is poured between the side templates and side walls of the pits.

7. The seamless expansion device according to claim 6, wherein each said dowel bar comprises a threaded steel tube and a flexible sleeve, the flexible sleeve has a sealed end and an open end, a spring in a compressed state is arranged in the flexible sleeve, the open end of the flexible sleeve is disposed around the threaded steel tube and partially overlapped with the threaded steel tube, an overlap between the flexible sleeve and the threaded steel tube penetrates into the through-hole formed in the corresponding angle bar and clamped by means of retaining rings located on two sides of the angle bar, and the flexible sleeve is located in the pouring trough.

8. The seamless expansion device according to claim 7, wherein each said embedded bar is configured as an inverted U-shaped structure and comprises a top horizontal section and vertical sections connected to two ends of the horizontal section.

9. The seamless expansion device according to claim 8, wherein longitudinal bars are fixed between the embedded bars, and axes of the longitudinal bars is parallel to a length direction of the expansion joint.

10. A construction process for the seamless expansion device according to claim 6, comprising the following steps:
S1: cutting and chiseling the asphalt concrete pavement layer and the box girders to expose the embedded bars and the bridge expansion joint, and in a case where no embedded bar is used, implanting steel bars equidistantly;
S2: laying the two side templates, fixing the side templates above the bridge expansion joint by welding, and spraying a foam adhesive to overlap joints between the side templates and the bridge expansion joint to seal the overlap joints;
S3: placing the comb plate above the side templates, and preliminarily fixing the first shear nails at a bottom of the comb plate to the embedded bars by binding;
S4: determining, by measurement, positions of the anchor bolts; after a design height, a distance to the edges and an angle of the anchor bolts are determined, fixing the anchor bolts to the embedded bars by welding; enabling screws of the anchor bolts to penetrate into one sides of the adjusting base plates, and preliminarily binding and fixing the other sides of the adjusting base plates to the embedded bars by means of the second shear nails at the bottoms of the adjusting base plates; adjusting positions of the adjusting base plates to design positions, and welding the second shear nails to the embedded bars;
S5: welding the two ends of the comb plate to the adjusting base plates, welding the side templates to a bottom surface of the comb plate, spraying a foam adhesive to the welding joints, unbinding the first shear nails at a bottom of the comb plate from the embedded bars, and fixing the first shear nails to the embedded bars by welding;
S6: placing the external angle bars on the adjusting base plates, fixing the external angle bars by means of nuts of the anchor bolts, enabling the dowel bars to penetrate into preformed holes in the external angle bar, and fixing the dowel bars to the external angle bars by means of the retaining rings, such that the pouring trough is defined;
S7: pouring the cement concrete via gaps between the external angle bars and the asphalt concrete pavement layer, and starting a next construction step when the concrete is cured to 90% of the design strength;
S8: uniformly mixing the negative-Poisson's-ratio unit and the high-toughness resin cementing material in proportion to form a low-Poisson's ratio resin mixture, directly pouring the low-Poisson's ratio resin mixture in the pouring trough until the low-Poisson's ratio resin mixture is as high as the asphalt concrete pavement layer on two sides, performing secondary trowelling on uneven portions, and forming the low-Poisson's-ratio elastomer after solidification; and
S9: resuming traffic after curing for 24 hrs.
